(19) United States
(12) Patent Application Publication
(10) Pub. No.: US 2025/0024795 A1
(43) Pub. Date: Jan. 23, 2025

(54) SMART TERRAPONIC GARDENING SYSTEM

(71) Applicant: Ark Designs LLC, West Bloomfield, MI (US)

(72) Inventor: Adam Ostroff, West Bloomfield, MI (US)

(73) Assignee: Ark Designs LLC, West Bloomfield, MI (US)

(21) Appl. No.: 18/778,279

(22) Filed: Jul. 19, 2024

Related U.S. Application Data
(60) Provisional application No. 63/527,896, filed on Jul. 20, 2023.

(51) Int. Cl. A01G 18/69

(52) U.S. Cl. CPC A01G 18/69

(57) ABSTRACT

A smart terraponic gardening system is provided that includes a first reservoir configured to contain a liquid and a second reservoir configured to contain a growing medium for a plant or fungus. A light source and a watering system are provided. A control unit is in electronic communication with the light source and the watering system. At least one sensor of a camera, a temperature sensor, or a humidity sensor is provided in signal communication with the control unit to adjust growing conditions based on the sensor output. In some instances, the control unit is programmed to maintain growing conditions for a specific plant of fungus growing in the second reservoir. The program in some instances is associated with a library of target plants or fungi, and their associated idealized growing conditions.

### RELATED APPLICATIONS

This application is a non-provisional application that claims priority benefit of U.S. Provisional Application Ser. No. 63/527,896 filed Jul. 20, 2023; the contents of which are hereby incorporated by reference.

### FIELD OF THE INVENTION

The present invention relates to devices for indoor gardening, and more particularly, it relates to smart devices for indoor terraponic gardening.

### BACKGROUND OF THE INVENTION

Terrariums are small-scale ecosystems contained in a container that is either entirely sealed or partially open to the surrounding environment. Terrariums typically include soil, rocks, plants, and other decorative items. Terrariums can reflect any ecosystem on earth as long as they are maintained properly.

Terrariums are appealing because they bring a touch of nature and greenery inside homes, apartments, and offices to allow for easy, low-maintenance, indoor gardening. Terrariums also allow gardeners to maintain plants all year long instead of taking a break during colder winter months and allow for a greater variety of plants, such as tropical plants, to be grown in spaces they may not normally thrive.

Like indoor plants generally, terrariums provide many health and wellness benefits to the people that are in the same vicinity. They are known to reduce stress, lower heart rate, and bring blood pressure levels to more normal ranges. Exposure to plants is also linked to decreased anger, tension, anxiety, and depression, and increased energy levels. Plants are also thought to increase productivity, creativity, relaxation, and concentration.

Furthermore, through processes such as phytoremediation and transpiration, the plants in indoor terrariums work to purify the air and increase its relative humidity. Houseplants are also known for their ability to filter out and reduce environmental impurities and toxins such as benzene, trichloroethylene, and formaldehyde, cleaning up the air. They also reduce overall carbon dioxide levels.

Terrariums are also a fantastic learning tool for kids and adults alike. These miniature ecosystems put science up close and personal for an audience, allowing them to closely watch how plants grow and how the water cycle operates through the system.

Unfortunately, some environments are not favorable for terrariums. For example, indoor spaces that lack sufficient light from windows or that experience temperature or humidity swings are often not suitable for terrariums, thereby depriving dwellers of such spaces of the many benefits afforded by terrariums. Furthermore, terrariums can fail to thrive when they are not adequately maintained due to a lack of knowledge or forgetfulness as far as when to water the terrarium, how much water is required, and providing adequate light and humidity requirements.

A number of smart indoor gardening systems exist that remind a user to feed or water the plants grown therein and that provide a light source for the plants; however, those currently available are hydroponic or aeroponic systems, both of which cultivate plants without soil. In a hydroponic system, plants are grown in the absence of soil and roots are maintained in a substantially liquid environment while in an aeroponic system roots are maintained in an open-air environment instead of soil. While existing hydroponic and aeroponic indoor gardening systems provide a solution to some of the above-described problems associated with indoor gardening in general, these existing systems are not terraponic. Without the presence of soil in these existing indoor growing systems, terrariums are not possible, full eco systems are not achievable, growable plant species are limited, and plants grown therein lack the flavor and nutrients only obtained via a terraponic growth environment.

Thus, there exists a need for a smart terraponic gardening system.

### SUMMARY OF THE INVENTION

A smart terraponic gardening system is provided that includes a base. A first reservoir defines a first volume. The first reservoir is configured to contain a liquid within the first volume. A second reservoir defines a second volume and is configured to contain a growing medium. A light source is coupled to a lid in a position above the second reservoir and configured to project light toward the second reservoir. A watering system is provided that includes a pump in fluid communication with the first volume of the first reservoir, a liquid outlet coupled to the lid is provided in a position above the second reservoir. A conduit fluidly connects the liquid outlet to the pump. The watering system is configured to dispense the liquid contained within the first volume of the first reservoir from the liquid outlet onto the growing medium contained within the second volume of the second reservoir. A control unit is in electronic communication with the light source, the watering system, and the air handling system. At least one sensor of a camera, a temperature sensor, or a humidity sensor is provided in signal communication with the control unit to adjust growing conditions based on the sensor output. In some instances, the control unit is programmed to maintain growing conditions for a specific plant of fungus growing in the second reservoir. The program in some instances is associated with a library of target plants or fungi, and their associated idealized growing conditions.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view of a smart terraponic gardening system according to embodiments of the present invention;

FIG. 2 is an exploded perspective view of the smart terraponic gardening system of FIG. 1;

FIG. 3 is an exploded side view of the smart terraponic gardening system of FIG. 1; and

FIGS. 4A-4G are sketches of designs of a smart terraponic gardening system according to embodiments of the present invention.

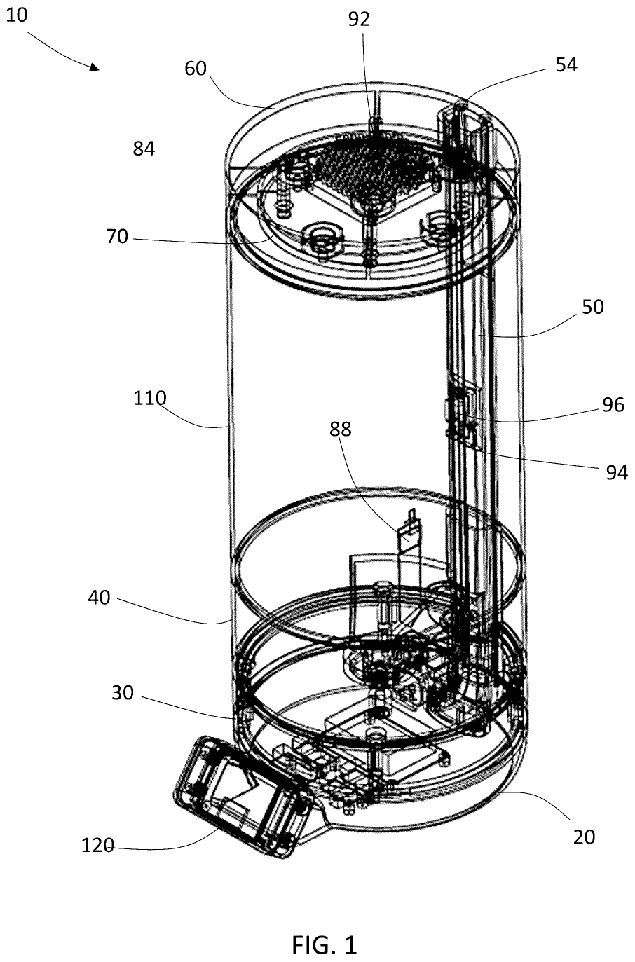

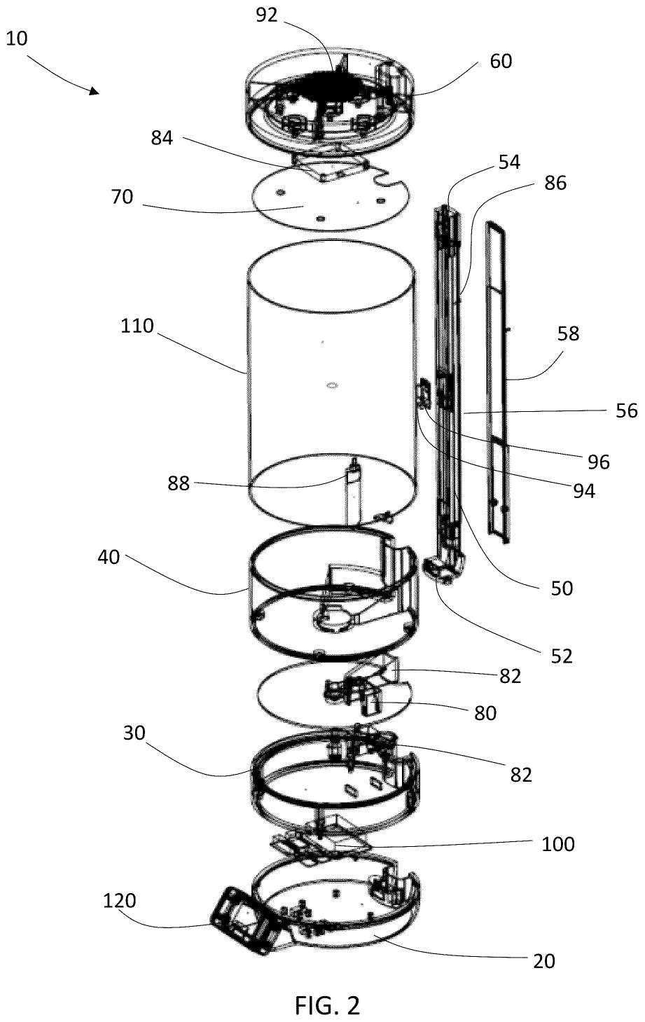

### DESCRIPTION OF THE INVENTION

The present invention has utility as a smart terraponic gardening system and a mini ecosystem. The smart system monitors and controls the conditions of the system based on the type of environment being cultivated, so that any type of environment is able to thrive within the system regardless of the environmental conditions outside of the system. The inventive system is versatile and customizable, allowing a user to create unique landscapes with found or purchased plants and elements. Once a given landscape is built within the inventive terraponic gardening system, a combination of sensors, controls, and in some embodiments cloud-based systems monitor the environment to adjust parameters such as water, humidity, lighting, temperature, and air flow according to the specific type of ecosystem built. The inventive smart terraponic gardening system additionally includes a mobile application that sends information to a phone or tablet computer in real time regarding the status of the ecosystem within the terrarium. Additionally, the application will alert a user when the user is needed to adjust any element of the eco system, for example provided additional water or nutrients.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

According to embodiments, the present invention provides a smart terraponic gardening system 10 that includes a base 20, a first reservoir 30, a second reservoir 40, a spine 50, a lid 60, a light source 70, a watering system, an air handling system, and a control unit 100. According to inventive embodiments, any of the base 20, the first, reservoir 30, the second reservoir 40, the spine 50, and the lid 60 are opaque or transparent. The inventive terraponic gardening system is useful for decorative purposes, educational purposes, indoor gardening purposes, and indoor farming purposes. That is, the inventive terraponic gardening system 10 adds a natural element to home or office settings and allows for plants to be maintained indoors in a space that otherwise would not be suitable for gardening due to, for example, poor lighting or poor temperature regulation. The inventive system 10 may be used to grow a wide variety of plants including purely aesthetic plants; fairy garden scenes; plants, herbs, vegetables, and fruits for consumption; or controlled substances including for example marijuana or psychedelic mushrooms. Given that the inventive system 10 is a terraponic system, as opposed to a hydroponic or aeroponic system, the plants grown therein are grown through micronutrient extraction from the growth medium and support of symbiotic soil fungi, thereby resulting in better taste and more natural growth patterns and outcomes. The present invention may be used for seed propagation. The inventive system 10 additionally has benefits as a light source that treats seasonal affective disorder and improves mood. The inventive system 10 is further useful as an educational tool for children and adults alike, allowing for better understanding of how various ecosystems functions, water cycles, and growth cycles. Additionally, the inventive system 10 allows for education related to software coding, allowing users to build their own code to maintain the various environmental parameters of the terrarium and monitor the progress thereof and adjust the code accordingly.

According to inventive embodiments, the base 20 is a vessel having a height and defining a base volume. According to embodiments, the base 20 is formed of a plastic material. The base 20 is provided is a variety of shapes and sizes, including a cylinder, as shown throughout the figures. According to embodiments, the base 20 includes a plurality of anti-slip pads 22 positioned on a bottom surface thereof to ensure that the base 20 securely rests upon a horizontal surface upon which it is place, which may include a window sill, a table top, a shelf, a floor surface, or a counter.

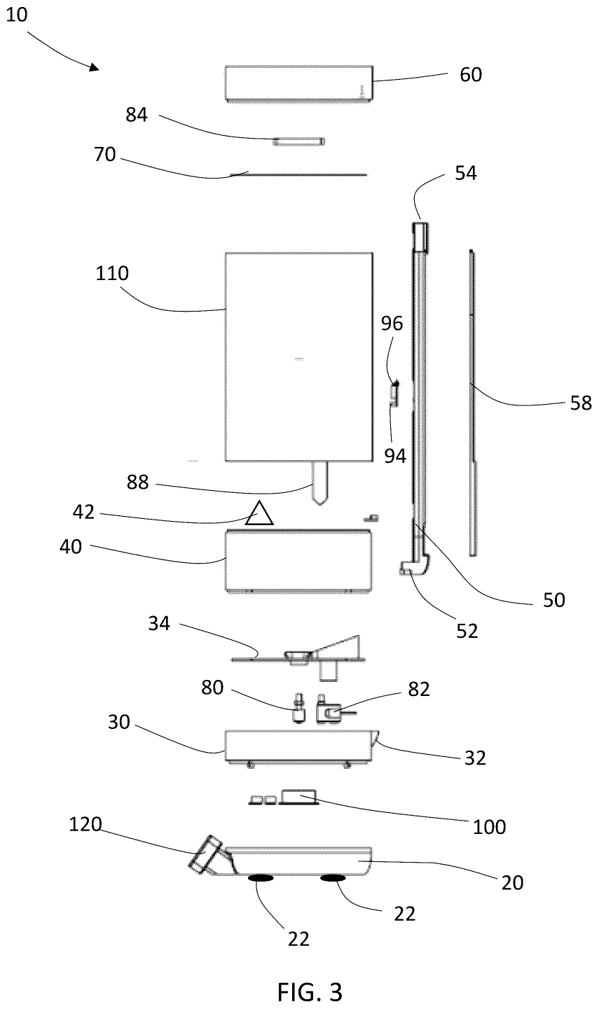

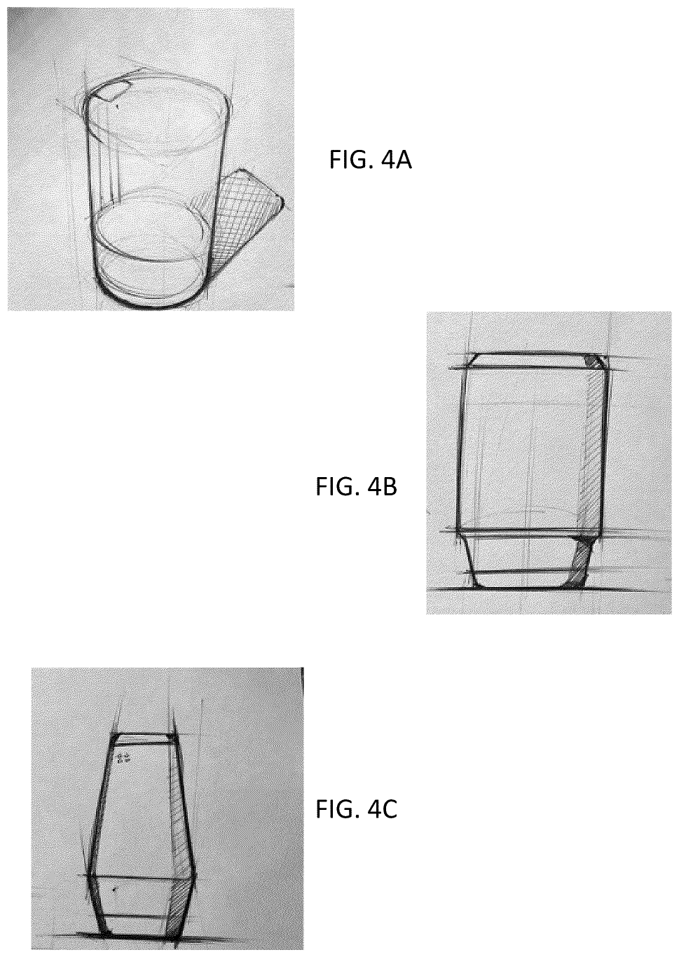

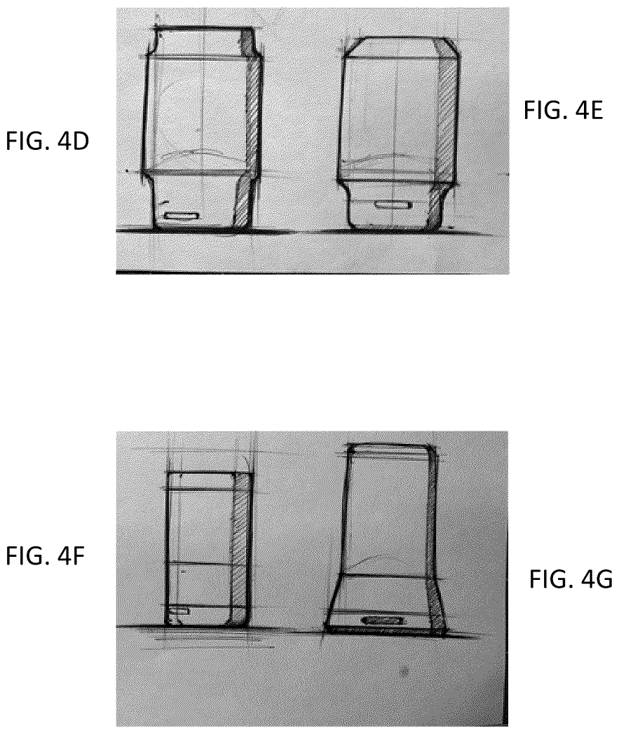

According to inventive embodiments, the first reservoir 30 is a vessel having a height and defining a first volume. According to embodiments, the first reservoir 30 is formed of a plastic material. The first reservoir 30 is provided is a variety of shapes and sizes, including a cylinder, as shown throughout the figures. According to inventive embodiments, the first reservoir 30 is configured to be supported on the base 20. The first volume of the first reservoir 30 is configured to contain a liquid therein. According to inventive embodiments, the liquid is water or a combination of water and liquid nutrients. According to inventive embodiments, the first reservoir 30 includes a filling port 32, as shown in FIG. 3 for adding the liquid to the first volume of the first reservoir 30. According to embodiments, the first reservoir 30 includes a bottom, a side wall, and a top. The bottom and the side wall are formed or joined together to ensure that the liquid contained therein does not leak out, while the top 34 is likewise formed or joined to the side wall or alternatively removable from the side wall, for ease of cleaning the first volume and repair and maintenance of components of the water system that are contained within the first reservoir 30. According to inventive embodiments, the first reservoir 30 is configured to be stacked upon the base 20 is an engaged manner such that the first reservoir 30 is removable from the base 20, but not likely to be easily slid or pushed off of the base 20. According to some inventive embodiments, the first reservoir 30 additionally includes a fertilizer reservoir therein that is configured to contain liquid nutrients and meter the liquid nutrients into the first volume of the first reservoir 30 so as to mix with the liquid contained therein prior to application to the growth medium. In still other embodiments, the first reservoir 30 is remote from the base 20 and it is a appreciated that a single reservoir 30 can supply several inventive gardening systems. According to inventive embodiments, the fertilizer reservoir includes a sensor that is in electronic communication with the control unit 100 that is configured to communicate the level of liquid nutrients contained therein. Based on this information, the control unit 100 is configured to provide an alter to a user when the level of the liquid fertilizer drops below a threshold amount.

According to inventive embodiments, the second reservoir 40 is a vessel having a height and defining a second volume. According to embodiments, the first reservoir 30 is formed of a plastic material. The second reservoir 40 is provided is a variety of shapes and sizes, including a cylinder, as shown throughout the figures. According to inventive embodiments, the second reservoir 40 is configured to be supported on the first reservoir 30. The second volume of the second reservoir 40 is configured to contain a growing medium, which according to embodiments is soil or a combination of soil and any of charcoal, sphagnum, and pebbles. The growing medium contained within the second volume of the second reservoir 40 is configured to receive at least one plant therein. The top of the growing medium defines a growing surface upon which additional elements may be placed, for example including rocks, moss, decorations, and additional plants. According to embodiments, the second reservoir 40 includes a bottom and a side wall. The bottom and the side wall are formed or joined together to ensure that the growing medium contained therein does not leak out. The top of the second reservoir 40 is open so that the plants contained within the growing medium are able to grow unrestricted. According to inventive embodiments, at least one small cover 42 is provided with the system 10, which may be used during seed propagation to enclose delicate seedlings planted in the growing medium within the second volume of the second reservoir 40. According to inventive embodiments, the second reservoir 40 is configured to be stacked upon the first reservoir 30 is an engaged manner such that the second reservoir 40 is removable from the first reservoir 30, but not likely to be easily slid or pushed off of the first reservoir 30.

According to inventive embodiments, the spine 50 has a first end 52 and a second end 54 and defines an internal channel 56 extending from the first end 52 to the second end 54. The spine 50 may be formed as a single piece or may be formed as two pieces including the spine 50 and a spine cover 58 that is configured to couple to the spin 50, with the internal channel 56 being formed therebetween. The first end 52 of the spine 50 is coupled to the base 20 and extends vertically therefrom. According to embodiments, as shown in the figures, the first reservoir 30 and the second reservoir 40 are formed with an indent in the sidewall thereof to accommodate the spine 50 as it vertically extends. According to inventive embodiments, the spine 50 is configured to telescope or otherwise change overall length so that a height thereof is adjustable. This feature allows the inventive system to be made smaller for shipping, transporting, and storage purposes and also allows for the lid 60 and light source 70 of the system to be adjustably positioned relative to the growing surface to accommodate different plant heights and different stages of growth.

According to inventive embodiments, the lid 60 is a vessel having a height and defining a lid volume. According to embodiments, the lid 60 is formed of a plastic material. The lid 60 is provided is a variety of shapes and sizes, including a cylinder, as shown throughout the figures. According to inventive embodiments, the lid 60 is coupled to the second end 54 of the spine 50. According to embodiments, the lid 60 includes a bottom, a side wall, and a top. The bottom and the side wall are formed or joined together, while the top is removable from the side wall, for ease access to the lid volume for repair and maintenance of components of the water system and the air handling system that are contained within the lid. According to inventive embodiments, the bottom portion of the lid 60 includes through holes therein so that components situated within the lid volume are in fluid communication with the area above the growing surface. In some inventive embodiments, the height of the lid 60 is adjustable.

According to embodiments, the light source 70 is coupled to the lid 60 in a position above the second reservoir 40 so that the light source 70 is able to project light toward the second reservoir 40. According to embodiments, the light source 70 includes a plurality of full spectrum light emitting diode (LED) grow lights. According to inventive embodiments, the light source 70 includes blue, red, and white grow lights that may be separately controlled so the light source 70 provides a full spectrum of light for blooming control and to optimize the growing conditions within the system 10 at a given time. According to inventive embodiments, the light source 70 additionally includes a UV-C LED for sterilizing the various components of the system 10 and particularly the growth chamber when it is empty. According to inventive embodiments, the light source 70 is configured to be operated in a manner that simulates various light conditions found in nature, for example including a thunderstorm, the twinkle of starts, a bright sunny day, sunrise, and sunset. According to some inventive embodiments, the light source 70 in conjunction with the control unit 100 is configured to provide adjustable wavelengths of the lights of the light source 70. For example, the wavelength of the light source 70 may be adjusted such that it treats seasonal affective disorder or to further optimize the growing conditions based on the various plants being cultivated within the growth chamber. According to embodiments, the light source 70 and its wavelengths are turned on and off and adjusted based on a timer and/or calendar setting that is ultimately controlled by the control unit 100. A light sensor such as a photometer is provided in some inventive embodiments, to assess light exposure as it is appreciated that target plants are exposed to light from the light source 70 as well as ambient sources such as room light, alone or in combination with sunlight.

According to inventive embodiments, the watering system of the inventive system 10 includes a pump 82 in fluid communication with the first volume of the first reservoir 30, a liquid outlet 84 coupled to the lid 60 in a position above the second reservoir 40, and a conduit 86 positioned within the internal channel 56 of the spine 50 to fluidly connect the liquid outlet 84 to the pump 82. The watering system is configured to dispense the liquid contained within the first volume of the first reservoir 30 from the liquid outlet 84 onto the growing medium contained within the second volume of the second reservoir 40, plants growing from the growing medium, plants planted therein, and objects provided on the growing surface thereof. According to embodiments, the pump 82 is positioned within the first volume of the first reservoir 30 or within the volume of the base 20. According to embodiments, the liquid outlet 84 is configured to drip the liquid onto the growing medium, plants planted therein, and objects provided on the growing surface thereof, to for example simulate rainfall. According to embodiments, the liquid outlet 84 is configured to mist the liquid onto the growing medium, plants planted therein, and objects provided on the growing surface thereof, to for example simulate fog or a light rain. According to inventive embodiments, the watering system additionally includes at least one moisture sensor 88 positioned within the second volume of the second reservoir 40. The moisture sensor 88 is configured to detect the amount of moisture present in the growing medium and to communicate that information to the control unit 100 so that the growing medium may be watered as needed so that the system 10 maintains ideal growing conditions for the plants therein and the specific ecosystem being cultivated. According to embodiments, the moisture sensor 88 is configured to extend the full depth of the growing medium within the second volume of the second reservoir 40. According to inventive amendments, the watering system additionally includes a liquid level sensor 80 positioned within the first volume of the first reservoir 30. The liquid level sensor 80 is configured to determine the level of liquid present in the first volume of the first reservoir 30. The liquid level sensor 80 is in electronic communication with the control unit 100 to provide information to the control unit 100 regarding the level of the liquid contained within the first volume of the first reservoir 30. The control 100 is then configured to alert a user when the liquid level falls below a designated threshold to prompt the user to add more water to the first volume within the first reservoir 30 via the filling port 32. According to inventive embodiments, the water system additionally or alternatively includes a mechanism for providing the liquid directly to the grown the medium.

According to some inventive embodiments, the air handling system includes a fan 92 positioned within the lid volume of the lid 60. The fan 92 is in fluid communication with the area above the growing medium contained within the second volume of the second reservoir 40 via through holes provided in the bottom surface of the lid 60. The fan is in electronic communication with the control unit 100 so that the control unit 100 is able to turn the fan 92 on and off based on a timer or information received from various sensors of the air handling system. For example, according to some inventive embodiments, the air handling system includes a temperature sensor 94 and/or humidity sensor 96 in electronic communication with the control unit 100 to provide information thereto regarding the temperature and/or the humidity of the system 10. The control unit 100 is then able to respond to that information by controlling the water system or the air handling system to adjust the conditions of the system 10 and maintain those conditions to the optimal growing conditions for a given eco system being cultivated. As shown in the figures, the temperature sensor 94 and/or humidity sensor 96 are provided on the spine 50. According to some inventive embodiments, the air handling system additionally includes a heating unit that is configured to adjust the temperature of the system 10, particularly the growth chamber, in response to information received by the control unit 100 from the temperature sensor 94. According to embodiments, the air handling system additionally includes an air filter positioned at an air intake and/or a seal positioned at an air exhaust, which allows for a sterile environment to be maintained when the growth area is sealed using a transparent enclosure portion 110, which is further detailed below. According to some inventive embodiments, the air handling system additionally includes a shutter positioned at an air exhaust to close off the exhaust and/or fan when the system 10 determines it is advantageous to do so, for example when the fan 92 is not in use.

According to embodiments, the control unit 100 is positioned within the base 20 and is in electronic communication with the light source 70, the watering system, and the air handling system. According to some inventive embodiments, the control unit 100 is in electronic communication with the light source 70 via at least one wire that runs through the internal channel 56 of the spine 50. The control unit is configured to turn the light unit 70 on and off and adjust the brightness and color thereof to optimize the growing conditions of the system 10 based on the information received from the various sensors and based on the information inputted to the system 10 regarding the type of plants or eco system being cultivated. According to some inventive embodiments, the control unit 100 is in electronic communication with the watering system via at least one wire that is positioned within the base 20. The control unit 100 is configured to turn the watering system on and off so that the growing medium may be watered as needed based on the moisture sensor 80 and other information received from the various sensors and based on the information inputted to the system 10 regarding the type of plants or eco system being cultivated so that the system 10 maintains ideal growing conditions for the plants and the specific ecosystem being cultivated. According to embodiments, the control unit 100 is in electronic communication with the air handling system via at least one wire that runs through the internal channel 56 of the spine 50. The control unit 100 is configured to turn the fan 92 of the air handling system on and off based on a timer or information received from various sensors of the air handling system so that the system 10 maintains ideal growing conditions for the plants and the specific ecosystem being cultivated.

According to some inventive embodiments, the inventive system 10 additionally includes a transparent enclosure portion 110 that is configured to be removably positioned between an upper end of the second reservoir 40 and a lower end of the lid 60. This transparent enclosure portion 110 is configured to surround and enclose the growing area so that the conditions within the system 10 may be maintained separate from the external environment in which the system 10 is positioned. The transparent enclosure portion 110 is configured to seal the growth area to form a sealed, sterile growth chamber, which may be useful to various ecosystems, for seed propagation, and for growing mushrooms with mycelium spawn bags or with organic growth media.

According to still other inventive embodiments, the inventive system additionally includes a user interface 120 that is in electronic communication with the control unit 100. According to some inventive embodiments, the user interface 120 is coupled to the base 20, as shown in the figures or alternatively is an application running on a wireless portable device, such as a phone or tablet. The user interface 120 or application version is configured to display information about any of the light source 70, the water system, the air handling system, or a combination thereof. The user interface 120 or application version is additionally configured to display alerts to a user to prompt the user to interact with the system 10. For example, the user interface 120 or application version may prompt a user to add liquid to the first reservoir 30 when the level of the liquid therein drops below a threshold amount or to provide fertilizer to the growing medium. Furthermore, the user interface 120 or application version is configured to receive inputs, including for example a user input regarding the type of plants grown therein and the type of ecosystem to be cultivated. According to some inventive embodiments, the user may specify a single plant that is being cultivated within the system 10 or may input several plants that are being cultivated therein. With this information, the control unit 100 is configured to optimize the growth conditions of the system based on the plant or plants specified. For example, when multiple plants are being cultivated within the system 10, the control unit 100 will determine a hybrid set of conditions based on the plants present, so that the conditions for all plants present therein may be best optimized and grown together. In other inventive embodiments, the control unit can access a library of common target plants to be grown and associated idealized conditions as to factors such as light, nutrients, humidity, or any combination thereof. It is appreciated that the library or is readily stored in a nonvolatile memory device associated with the control unit or is access from cloud storage via an application running on the wireless portable device.

In still other embodiments, a camera functions as a sensor and analyzes camera derived images such factors such as foliage mass, shades of green, discolorations indicative of disease, and provides such information as signals to the control unit or an application running on a portable computing device to display information about problems and in still other embodiments, suggested modifications to any of the light source, the water system, the air handling system, or a combination thereof. According to some inventive embodiments, the control unit 100 is configured to wirelessly communicate with a portable computing device to display information about any of the light source 70, the water system, the air handling system, or a combination thereof and to set and control environmental parameters for the system 10. In still other embodiments, a camera is accessible remotely via a wireless portable computing device so a user may check the status of the plants in an inventive gardening system remotely. The camera is also amenable to collecting and transmitting time lapsed images to the wireless portable computing device.

According to some inventive embodiments, the inventive system 10 is provided as a terrarium kit that includes the inventive system 10 and instructions for building and maintaining various ecosystems therein and for using, operating the system 10, and for coding the control unit 100 to optimize the growth conditions for various ecosystems. According to embodiments, the inventive kit additionally includes growth medium, plants, decorative or natural elements, tweezers, rocks, scissors, and/or additional materials for building and maintaining an ecosystem within the system.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A smart terraponic gardening system comprising:
a base;
a first reservoir defining a first volume, the first reservoir configured to contain a liquid within the first volume;
a second reservoir defining a second volume, the second reservoir configured to contain a growing medium within the second volume;
a lid having a lid height and defining a lid volume;
a light source coupled to the lid in a position above the second reservoir and configured to project light toward the second reservoir;
a watering system comprising a pump in fluid communication with the first volume of the first reservoir, a liquid outlet coupled to the lid in a position above the second reservoir, and a conduit fluidly connect the liquid outlet to the pump, the watering system configured to dispense the liquid contained within the first volume of the first reservoir from the liquid outlet onto the growing medium contained within the second volume of the second reservoir;
at least one sensor of a temperature sensor, camera, or a humidity sensor in signal communication with the control unit;
a control unit in electronic communication with the light source, the watering system, and the air handling system, the control unit operating a computer program to maintain growing conditions for a specific plant of fungus growing in the second reservoir.

2. The smart terraponic gardening system of claim 1 further comprising an air handling system comprising a fan positioned within the lid volume and in fluid communication with an area above the growing medium contained within the second volume of the second reservoir.

3. The smart terraponic gardening system of claim 1 wherein the liquid contained in the first volume of the first reservoir is water that optionally contains dissolved or suspended nutrients.

4. The smart terraponic gardening system of claim 1 wherein the first reservoir includes a filling port for adding the liquid to the first volume of the first reservoir.

5. The smart terraponic gardening system of claim 1 wherein the program is part of a library of programs for specific idealized growing conditions for target plants or fungi.

6. The smart terraponic gardening system of claim 1 wherein at least one of the first reservoir or the second reservoir is removable.

7. The smart terraponic gardening system of claim 1 further comprising a spine defining an internal channel extending vertically from the first reservoir.

8. The smart terraponic gardening system of claim 7 wherein the spine is configured to telescope or otherwise change overall length so that a height thereof is adjustable.

9. The smart terraponic gardening system of claim 2 further comprising a transparent enclosure portion configured to be removably positioned between an upper end of the second reservoir and a lower end of the lid.

10. The smart terraponic gardening system of claim 1 wherein the light source is a plurality of full spectrum light emitting diode (LED) grow lights and optionally includes a light sensor.

11. The smart terraponic gardening system of claim 1 wherein the moisture sensor is present and positioned within the second volume of the second reservoir to provide a signal to the control unit or an application.

12. The smart terraponic gardening system of claim 1 wherein the temperature sensor is present to provide a signal to the control unit or an application.

13. The smart terraponic gardening system of claim 1 wherein the camera is present and an image produced therefrom is color analyzed to provide a signal to the control unit or an application to modify growing conditions.

14. The smart terraponic gardening system of claim 1 wherein the humidity sensor present to provide a signal to the control unit or an application.

15. The smart terraponic gardening system of claim 1 wherein the control unit is in electronic communication with at least one of the lighting system, the watering system, or the air handling system to control output thereof.

16. The smart terraponic gardening system of claim 1 further comprising a user interface that is in electronic communication with the control unit.

17. The smart terraponic gardening system of claim 16 wherein the user interface is coupled to the base or is present in an application of a wirelessly coupled portable computing device.

18. The smart terraponic gardening system of claim 16 wherein the user interface is configured to display information about any of the light source, the water system, the air handling system, or a combination thereof.

19. The smart terraponic gardening system of claim 16 wherein the user interface is configured to receive inputs.

20. The smart terraponic gardening system of claim 1 wherein the control unit is configured to wirelessly communicate with a portable computing device to display via an application running on the portable computing device, information about any of the light source, the water system, the air handling system, or a combination thereof.
